(19) United States
(12) Patent Application Publication
(10) Pub. No.: US 2014/0094072 A1
(43) Pub. Date: Apr. 3, 2014

(54) ELECTRICAL CONTACT COMPONENT

(71) Applicants: Naoki Seki, Mie (JP); Katsunobu Yamada, Mie (JP); Yuichi Uchida, Osaka (JP); Susumu Arai, Nagano (JP)

(72) Inventors: Naoki Seki, Mie (JP); Katsunobu Yamada, Mie (JP); Yuichi Uchida, Osaka (JP); Susumu Arai, Nagano (JP)

(73) Assignee: PANASONIC CORPORATION, Osaka (JP)

(21) Appl. No.: 14/123,032

(22) PCT Filed: Mar. 8, 2012
(86) PCT No.: PCT/JP2012/055909

§ 371 Date: Nov. 27, 2013

(30) Foreign Application Priority Data
Jun. 3, 2011 (JP) 2011-124795
Jun. 21, 2011 (JP) 2011-137089

(51) Int. Cl. H01R 13/02

(52) U.S. Cl. CPC H01R 13/02
USPC 439/887; 977/742

(57) ABSTRACT

An electrical contact component includes a contact point part configured to provide an electrical connection by contact, and a mounting part configured to provide an external electrical connection by solder joining. A plating layer containing carbon nanotubes or carbon blacks is selectively formed on the surface of the contact point part. A plating layer having higher solder wettability than that of the plating layer containing the carbon nanotubes or carbon blacks is formed on the mounting part.

### TECHNICAL FIELD

The present invention relates to an electrical contact component used as a contact point component (contact point material) for an electric component such as a relay (for example, a power relay of an electronic vehicle), a switch, a connector, or a breaker.

### BACKGROUND ART

Heretofore, there has been provided an electronic component described in, for example, Japan Patent Publication No. 4032116. The electronic component has a wiring pattern.

In the electrical contact component, an expensive noble metal layer made of Au, Ag, Pt, Rh, Ru, Ir, or Pd or the like having excellent electrical conductivity is generally formed on the outermost surface of a contact point part in order to secure contact reliability and mountability. Since Au or Ag is a soft material, Au or Ag is often used as an alloy or a composite material such as Au—Co, Au—Ni, Ag—W, Ag—WC, Ag—Cu, Ag—Mo, Ag—CdO, Ag—Au, Ag—SnO, Ag—Pd, Ag—Ni, or Ag—ZnO in order to increase the hardness thereof. Au or Ag is also often subjected to a sealing treatment after noble metal plating in order to secure corrosion resistance.

However, since the noble metal is expensive, the cost of the electrical contact component is disadvantageously increased when the noble metal is used in large quantity. Since oxide which is apt to block an electric connection is formed on the surface of the contact point part after reflow, contact resistance in a low contact pressure region (a contact power of 9.8×10⁻³ N (1 gf) or less when a gold alloy-based plating layer is formed on the surface of the contact point part) is increased, which disadvantageously causes low contact reliability. Then, the eutectoid amount of plating is considered to be finely managed so that the contact reliability is not deteriorated. However, this disadvantageously causes complicated process management. Furthermore, when the sealing treatment is performed, an insulating oily component is used as a lubrication component, which disadvantageously deteriorates the contact reliability.

### SUMMARY OF THE INVENTION

Then, it is an object of the present invention to provide an electrical contact component having excellent contact reliability and mountability.

An electrical contact component of the present invention includes: a contact point part configured to provide an electrical connection by contact; and a mounting part configured to provide an external electrical connection by solder joining. A plating layer containing carbon nanotubes (hereinafter, CNTs) or carbon blacks (hereinafter, CBs) is selectively formed on the surface of the contact point part or the surface exposed by sliding wear and opening/closing or the like of the contact point part. A plating layer having higher solder wettability than that of the plating layer containing the CNTs or CBs is formed on the mounting part. The constitution provides the electrical contact component having excellent contact reliability and mountability.

In this constitution, it is preferable that the CNTs or CBs are projected from a surface of the plating layer containing the CNTs or CBs.

In this constitution, it is preferable that the plating layer containing the CNTs or CBs is formed by electrolytic plating or non-electrolytic plating.

In this constitution, it is preferable that the CNTs contain multi wall CNTs (hereinafter, MWCNTs).

In this constitution, it is preferable that the plating layer containing the CNTs contains the CNTs of 0.02 to 2.0% by mass based on the total amount thereof.

In this constitution, it is preferable that the plating layer containing the CBs contains the CBs of 0.02 to 2.0% by mass based on the total amount thereof.

In this constitution, it is preferable that the plating layer containing the CNTs or CBs is an amorphous plating layer, and the CNTs or CBs are exposed from a surface of the amorphous plating layer.

In this constitution, it is preferable that the amorphous plating layer is a Ni—P alloy plating film.

An electrical contact component of the present invention has a surface having an amorphous plating layer formed thereon. The amorphous plating layer contains a nanocarbon material exposed from a surface of the amorphous plating layer. Such a constitution has excellent contact reliability and corrosion resistance. In addition, the constitution can be inexpensively manufactured.

In this constitution, it is preferable that the electrical contact component contains a contact point part configured to provide an electrical connection by contact, and a mounting part configured to provide an electrical connection by solder joining; the contact point part has the surface having the amorphous plating layer formed thereon; and the mounting part has a plating layer formed thereon, the plating layer having higher solder wettability than that of the amorphous plating layer.

In this constitution, it is preferable that the nanocarbon material includes MWCNTs.

In this constitution, it is preferable that the nanocarbon material includes CBs.

In this constitution, it is preferable that the amorphous plating layer contains the nanocarbon material of 0.02 to 2.0% by mass based on the total amount thereof.

In this constitution, it is preferable that the amorphous plating layer is formed by electrolytic plating or non-electrolytic plating.

In this constitution, it is preferable that the amorphous plating layer is a Ni—P alloy plating film.

### BRIEF DESCRIPTION OF DRAWINGS

Preferred embodiments of the present invention will be further described in detail. For a better understanding of the other features and advantages of the present invention, the following detailed description is presented in connection with accompanying drawings:

FIG. 1A is a schematic side view of an electrical contact component of a first embodiment of the present invention;

FIG. 1B is a partial sectional view of the electrical contact component of the first embodiment of the present invention;

FIG. 1C is a partial sectional view of the electrical contact component of the first embodiment of the present invention;

FIG. 2A is a perspective view showing an example of a header of the electrical contact component of the first embodiment of the present invention;

FIG. 2B is a perspective view showing an example of a socket of the electrical contact component of the first embodiment of the present invention;

FIG. 3 is a schematic view showing an example of a method for forming a CNT plating layer of the first embodiment of the present invention;

FIG. 4 is a schematic view showing another example of the method for forming the CNT plating layer of the first embodiment of the present invention;

FIG. 5 is a schematic view showing still another example of the method for forming the CNT plating layer of the first embodiment of the present invention;

FIG. 6A is a schematic view showing yet another example of the method for forming the CNT plating layer of the first embodiment of the present invention;

FIG. 6B is a schematic view showing further another example of the method for forming the CNT plating layer of the first embodiment of the present invention;

FIG. 7A shows a surface SEM photograph (×1,000 times) of a CNT composite plating film produced in example 1 of the first embodiment of the present invention;

FIG. 7B shows a surface SEM photograph (×5,000 times) of a CNT composite plating film produced in example 1 of the first embodiment of the present invention;

FIG. 8 is a graph showing a reflow temperature profile used to evaluate contact reliability and mountability in the first embodiment of the present invention;

FIG. 9 is a graph showing the evaluation of the contact reliability in the first embodiment of the present invention;

FIG. 10 is a partial sectional view showing another example of the electrical contact component of the first embodiment of the present invention;

FIG. 11 is a surface SEM photograph of a CB plating layer formed in example 3 of the first embodiment of the present invention;

FIG. 12A is a partial sectional view of an electrical contact component of a second embodiment of the present invention;

FIG. 12B is a partial sectional view of the electrical contact component of the second embodiment of the present invention;

FIG. 13A is a schematic view showing further another example of a method for forming an amorphous plating layer containing a nanocarbon material of the second embodiment of the present invention;

FIG. 13B is a schematic view showing further another example of the method for forming the amorphous plating layer containing the nanocarbon material of the second embodiment of the present invention;

FIG. 14A is a surface SEM photograph (×5,000 times) of a contact point part of example 4 of the second embodiment of the present invention;

FIG. 14B is a surface SEM photograph (×10,000 times) of a contact point part of example 5 of the second embodiment of the present invention;

FIG. 15 is a graph showing a reflow temperature profile used to evaluate contact reliability in examples of the second embodiment of the present invention;

FIG. 16 is a graph showing the evaluation of the contact reliability in examples of the second embodiment of the present invention;

FIG. 17 is a photograph showing the evaluation of corrosion resistance in examples of the second embodiment of the present invention; and

FIG. 18 is a sectional view showing an example of a mounting part of the second embodiment of the present invention.

### BEST MODE FOR CARRYING OUT THE INVENTION

### First Embodiment

Hereinafter, a first embodiment of the present invention will be described.

An electrical contact component A is used as a terminal part of a connector, a moving contact point such as a switch or a relay, and a fixed contact point or the like. In particular, the electrical contact component A is suitably used in a low contact pressure region.

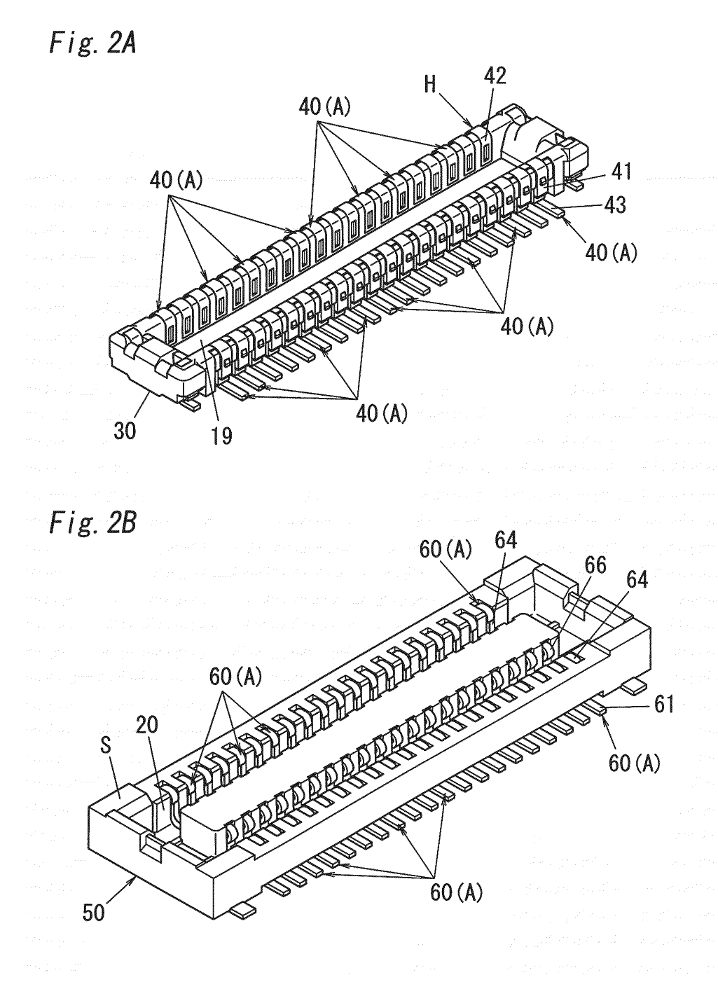

Examples of the connector using the electrical contact component A include a connector having a header H shown in FIG. 2A and a socket S shown in FIG. 2B. The header H includes a header body 30 and a plurality of header contacts 40. The header body 30 is made of an insulation material such as a synthetic resin. The header contacts 40 are made of an electrical conducting material. The header contacts 40 are held by the header body 30 according to insert molding, for example. The socket S includes a socket body 50 and a plurality of socket contacts 60. The socket body 50 is made of an insulation material such as a synthetic resin and is provided with a connection recess 20. The socket contacts 60 are made of a material having conductivity and elasticity. The socket contacts 60 are held by the socket body 50 such that the socket contacts 60 are in contact and conduction with the header contacts 40 inside the connection recess 20 in one-to-one correspondence with the header contacts 40 when the header H is inserted into the connection recess 20. The electrical contact component A of the present invention can be used as the header contacts 40 and the socket contacts 60.

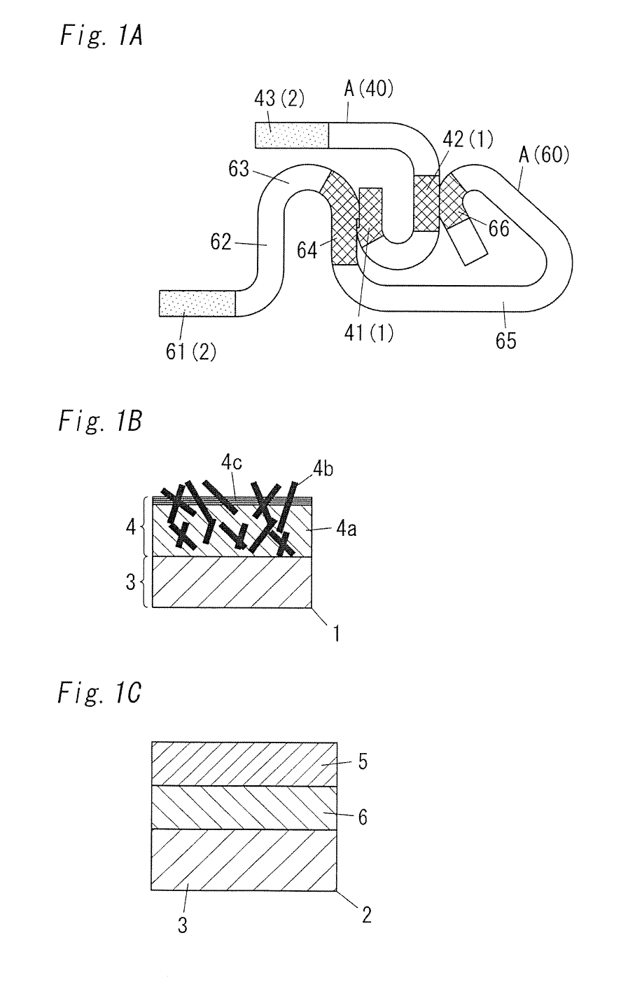

As shown in FIG. 1A, the header contact 40 includes a first contact part 41, a second contact part 42, and a terminal part 43. The first contact part 41 is exposed from left and right outer side surfaces of the header body 30, and is in contact with a first contact part 64 of the socket contact 60. The second contact part 42 is formed into a U shape nipping left and right edges of an inner recess 19 together with the first contact part 41. The second contact part 42 is exposed inward of the inner recess 19, and is in contact with a second contact part 66 of the socket contact 60. The terminal part 43 extends outward in the lateral direction from an upper end of the second contact part 42, and passes through a bottom surface of the inner recess 19. The terminal part 43 is projected laterally along an upper end surface (a lower end surface in FIG. 2A) of the header body 30, and is used for mounting.

The socket contact 60 includes a terminal part 61, a held part 62, a first connecting part 63, a first contact part 64, a second connecting part 65, and a second contact part 66. The terminal part 61 is projected from the socket body 50 such that its thickness direction is oriented in the vertical direction, and is used for mounting. The held part 62 is connected to one of left and right ends of the terminal part 61 located inward, and extends upward. The held part 62 is held by the socket body 50. The first connecting part 63 has one end connected to an upper end of the held part 62, and extends into one of left and right directions away from the terminal part 61. The first contact part 64 has one end connected to the other end of the first connecting part 63, and extends downward. The first contact part 64 is in contact with the header contact 40. The second connecting part 65 has one end connected to a lower end of the first contact part 64, and extends into one of left and right directions away from the held part 62. The second contact part 66 has a lower end connected to the other end of the second connecting part 65, and extends into a direction where the header H is extracted from the connection recess 20. The second contact part 66 elastically nips the header contact 40 between the first contact part 64 and the second contact part 66.

The first contact part 41 and the second contact part 42 of the header contact 40, and the first contact part 64 and the second contact part 66 of the socket contact 60 are in contact with a conductive member such as an electric circuit or the other electrical contact component, and are formed as a contact point part 1 for providing an electrical connection by the contact. The terminal part 43 of the header contact 40 and the terminal part 61 of the socket contact 60 are formed as a mounting part 2 for providing an electrical connection with a conductive member of the exterior (the other member) such as an electric circuit by solder joining.

The contact point part 1 is formed by providing a plating layer (hereinafter, referred to as a “CNT plating layer”) 4 containing carbon nanotubes (hereinafter, CNTs) on a surface of a base material 3 of the electrical contact component A. The mounting part 2 is formed by providing a plating layer (hereinafter, referred to as a “solder joint plating layer”) 5 having higher solder wettability than that of the CNT plating layer 4 on the surface of the base material 3. In FIG. 1A, the contact point part 1 is shown by cross-hatching, and the mounting part 2 is shown by a diagonal pattern.

The base material 3 is molded into a desired shape according to the intended use of the electrical contact component A. The base material 3 can be formed of a known metal material used for the electrical contact component such as copper or a copper alloy. Examples of the copper alloy include a Cu—Ti, Cu—Ti—Fe, Cu—Be, Cu—Sn—P based, Cu—Zn based, Cu—Ni—Zn based, Cu—Ni—Si based, and Cu—Fe—P based alloys.

As shown in FIG. 1B, the CNT plating layer 4 is formed by composite plating of a metal plating film 4a adhering to the surface of the base material 3 and CNTs 4b dispersed and incorporated in the metal plating film 4a.

The material and thickness or the like of the metal plating film 4a may be determined in consideration of adherability of the metal plating film 4a to the base material 3, performance of holding the CNTs 4b, and hardness of the metal plating film 4a. For example, the metal plating film 4a can be formed of a material such as Cu or Ni. The Ni plating film is preferable. This is because the Ni plating film is a metal film having excellent corrosion resistance, wear resistance, and chemical resistance, has good workability, and provides comparatively low treatment cost. The metal plating film 4a preferably has a thickness of 0.1 to 10 μm, and more preferably 1 to 5 μm.

The CNT 4b is a carbon material, which is chemically stable and has excellent electrical conductivity, slidability, and mechanical strength. A CNT having a diameter of 10 to 200 nm and a length of 1 to 20 μm is used as the CNT 4b. Examples of the CNT 4b include a single wall CNT obtained by cylindrically rolling a graphite sheet as one layer and a multi wall CNT obtained by rolling two or more graphite sheets as a multi-layer. The multi wall CNT has more excellent mass productivity than that of the single wall CNT, and can be comparatively inexpensively obtained. Thereby, the multi wall CNT can reduce cost, which is preferable.

In the CNT plating layer 4, the CNTs 4b are preferably formed so as to be projected from the surface of the metal plating film 4a. That is, as shown in FIG. 1B, some of the CNTs 4b, or all of the CNTs 4b contained in the metal plating film 4a are projected partly outside the surface of the metal plating film 4a. When a metal oxide film is formed on the surface of the metal plating film 4a, the CNTs 4b are preferably in contact with an inoxidized portion located inside (deep part) the metal oxide film 4c formed on the surface of the metal plating film 4a. Thereby, the CNTs 4b pass through the metal oxide film 4c formed on the surface of the metal plating film 4a in a solder reflow process or the like, and exist on the surface of the CNT plating layer 4. Therefore, the other conductive member is directly electrically connected to a metal located inside (deep part) the metal plating film 4a through the CNTs 4b having higher electric conductivity than that of the metal oxide film 4c having low electric conductivity. As a result, stably low contact resistance is obtained. It is considered that the adhesion and wear phenomena of the metal plating film 4a and the other metal conductive member are less likely to be generated by the CNTs 4b existing on the surface of the CNT plating layer 4, which can improve sticking resistance.

The CNT plating layer 4 preferably contains the CNTs 4b of 0.02 to 2.0% by mass based on the total amount thereof. When the content of the CNTs 4b is less than 0.02% by mass, there is a possibility that an improvement in contact reliability of the CNT plating layer 4 by the CNTs 4b is not sufficiently obtained. When the content of the CNTs 4b is more than 2.0% by mass, there is a possibility that the dispersibility of the CNTs 4b in a plating liquid is deteriorated or the adhesion of the CNT plating layer 4 to the base material 3 is deteriorated. That is, when the content of the CNTs 4b is within the above-mentioned range, the improvement in the contact reliability of the CNT plating layer 4 by the CNTs 4b is sufficiently obtained, and the dispersibility of the CNTs 4b in the plating liquid and the adhesion of the CNT plating layer 4 to the base material 3 can be sufficiently secured.

The solder joint plating layer 5 has higher solder wettability than that of the CNT plating layer 4. Since the CNT itself has hydrophobicity and the CNT plating layer 4 has large surface roughness, a solder is less likely to spread on the CNT plating layer 4 and to adhere tightly to the CNT plating layer 4. Therefore, if the CNT plating layer 4 is applied to the mounting part 2, there is a possibility that the joint strength of the electrical contact component A to the other conductive member is decreased, or much time and effort are taken to join the electrical contact component A, which deteriorates mountability. Accordingly, the solder joint plating layer 5 having more excellent solder wettability than that of the CNT plating layer 4 is formed on the mounting part 2. The solder joint plating layer 5 can be directly formed on the surface of the base material 3 using a noble metal plating film made of Au, Ag, Pt, Rh, Ru, Ir, Pd, or an alloy thereof or the like having excellent electrical conductivity, for example. As shown in FIG. 1C, a base plating layer 6 may be interposed between the solder joint plating layer 5 and the surface of the base material 3. In this case, a Ni plating film having excellent adhesion with the base material 3 can be used as the base plating layer 6. An Au plating film and an Au—Pd alloy plating film or the like having excellent electrical conductivity can be used as the solder joint plating layer 5 laminated on the surface of the base plating layer 6. The thickness of the base plating layer 6 is preferably 0.5 to 2 μm. The thickness of the solder joint plating layer 5 is preferably 0.01 to 5 μm, and more preferably 0.1 to 0.5 μm.

The above-mentioned electrical contact component A can be manufactured by selectively forming the CNT plating layer 4 on a portion to be the contact point part 1, of the base material 3 formed in a desired shape and selectively forming the solder joint plating layer 5 on a portion to be the mounting part 2, of the base material 3.

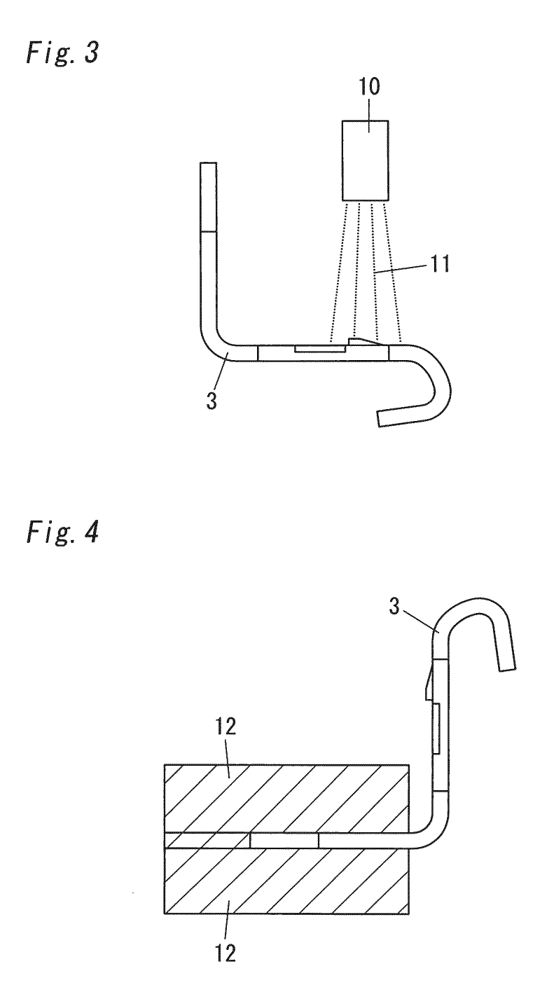

When the CNT plating layer 4 is selectively formed, various methods can be employed. For example, when a spot plating method is employed, as shown in FIG. 3, the CNT plating layer 4 can be formed by partially spraying a plating liquid 11 onto a place on which the CNT plating layer 4 is formed, on the surface of the base material 3 from a nozzle 10. The plating liquid 11 contains a metal component for forming the metal plating film 4a, and the CNTs 4b. In addition, the surface of the base material 3 can also be partially plated using a sparger.

The CNT plating layer 4 can also be selectively formed by a mask plating method. In this case, as shown in FIG. 4, a portion (for example, a place to be the mounting part 2) other than a place on which the CNT plating layer 4 is formed, on the surface of the base material 3 is covered with a mask 12. The base material 3 on which the mask 12 is provided is then immersed in the plating liquid. The CNT plating layer 4 can be formed on a place which is not covered with the mask 12, of the base material 3 by electrolytic plating or non-electrolytic plating.

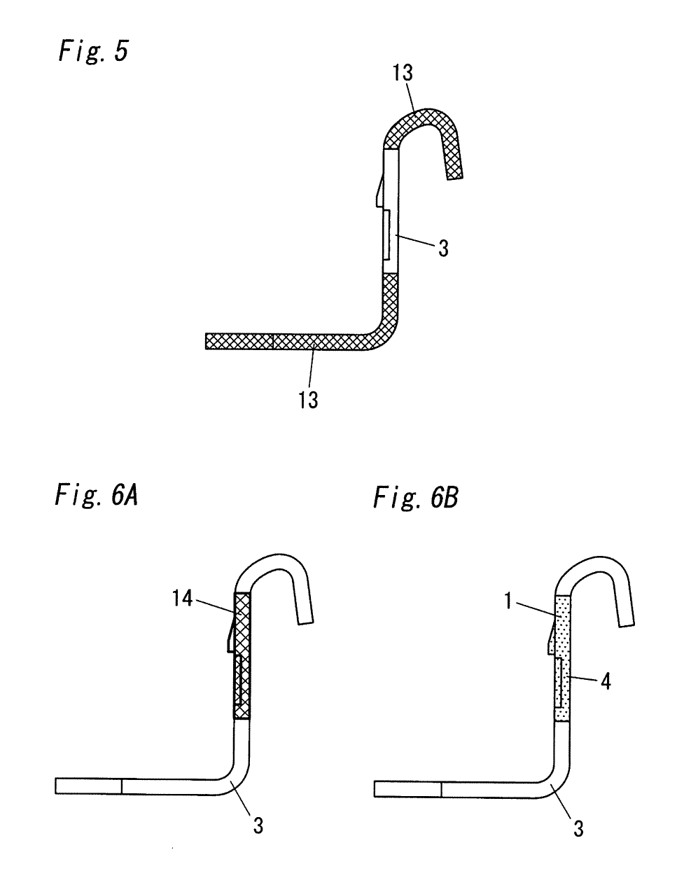

The CNT plating layer 4 can also be selectively formed by a resist plating method. In this case, as shown in FIG. 5, a portion (for example, a place to be the mounting part 2) other than a place on which the CNT plating layer 4 is formed, on the surface of the base material 3 is covered with a resist film 13 (represented by hatching in FIG. 5). The base material 3 on which the resist film 13 is provided is then immersed in the plating liquid. The CNT plating layer 4 can be formed on a place which is not covered with the resist film 13, of the base material 3 by electrolytic plating or non-electrolytic plating.

The CNT plating layer 4 can also be selectively formed by a catalyst plating method. In this case, as shown in FIG. 6A, a plating catalyst (a hatching portion of FIG. 6A) 14 adheres to the place on which the CNT plating layer 4 is formed, on the surface of the base material 3. Then, the base material 3 on which the plating catalyst 14 is provided is immersed in the plating liquid. As shown in FIG. 6B, the CNT plating layer (a dotted pattern portion of FIG. 6B) 4 can be formed on the place to which the plating catalyst 14 adheres, of the base material 3 by non-electrolytic plating.

The solder joint plating layer 5 and the base plating layer 6 can also be selectively formed by a known plating method such as sparger plating, partial immersion, felt plating or spot plating, or the same plating method as that in the case of the CNT plating layer 4.

The CNT plating layer 4 is formed on the contact point part 1 in the above-mentioned electrical contact component A. Therefore, the contact point part 1 can provide an electrical connection in a state where the contact of the contact point part 1 with the other conductive member is secured by the CNTs 4b even at a low contact pressure. The electrical contact component A can secure the contact reliability in the low contact pressure region even after solder reflow. The CNTs 4b are interposed between the metal plating film 4a of the CNT plating layer 4 and the other conductive member. Therefore, the adhesion and wear between the metal plating film 4a and the other conductive member can be reduced, and the sticking resistance can be improved. Furthermore, the CNT plating layer 4 can have less sliding wear and higher hardness than those of a plating layer made of only a metal, and thereby an improvement in life of the electrical contact component A can be achieved. Therefore, when the above-mentioned electrical contact component A is used as a contact point component (contact point material) such as a switch or a relay having a high opening and closing frequency, a sticking phenomenon is less likely to occur, and the improvement in life of the electrical contact component A can be easily achieved, which is preferable. Noble metal plating such as Au plating is not used for the contact point part 1, and thereby the electrical contact component A having high reliability can be provided at low cost. Meanwhile, the solder joint plating layer 5 having higher solder wettability than that of the CNT plating layer 4 and made of Au or the like is formed on the mounting part 2, and thereby high mountability can be secured. Therefore, the above-mentioned electrical contact component A can achieve both the contact reliability and the mountability.

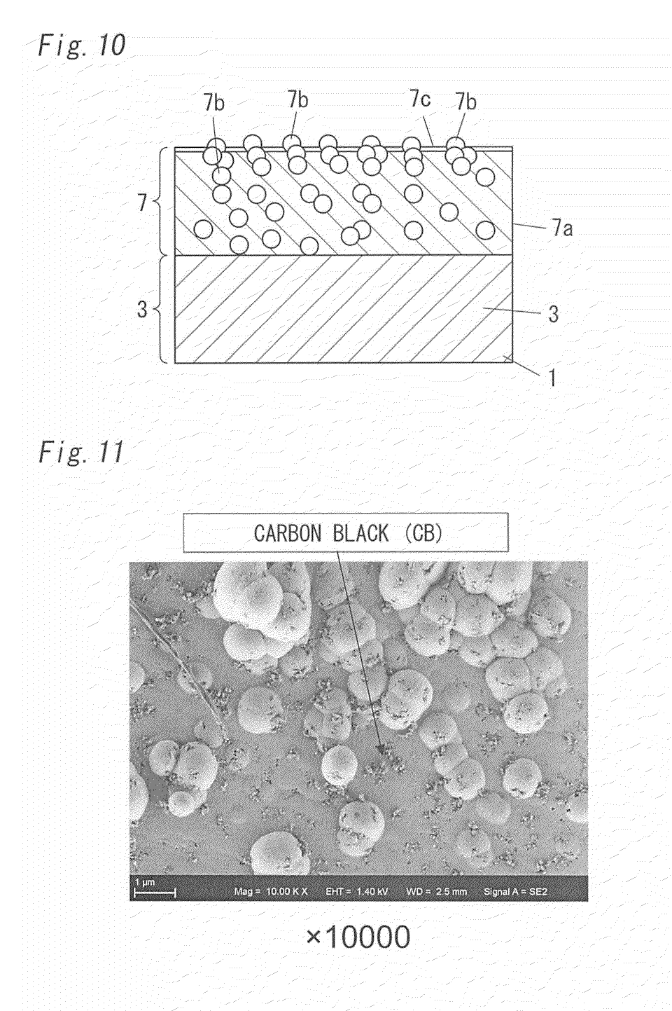

Another embodiment is shown in FIG. 10. In this electrical contact component A, a contact point part 1 is formed by providing a plating layer (hereinafter, referred to as a “CB plating layer”) 7 containing carbon blacks (hereinafter, CBs) on the surface of a base material 3 of the electrical contact component A. The other constitution is the same as that of the above-mentioned embodiment. A mounting part 2 is formed by providing a solder joint plating layer 5 having higher solder wettability than that of the CB plating layer 7 on the surface of the base material 3 as in FIG. 1C. The base material 3 can be formed of a known metal material used for the electrical contact component, such as copper or a copper alloy in the same manner as above.

The CB plating layer 7 contains CBs 7b in place of the CNTs 4b contained in the CNT plating layer 4. That is, as shown in FIG. 10, the CB plating layer 7 is formed by composite plating of a metal plating film 7a adhering to the surface of the base material 3 and CBs 7b dispersed and incorporated in the metal plating film 7a.

The material and thickness or the like of the metal plating film 7a may be determined in consideration of adherability of the metal plating film 7a to the base material 3, performance of holding the CBs 7b, and hardness of the metal plating film 7a in the same manner as above. For example, the metal plating film 7a can be formed of a material such as Cu or Ni. The Ni plating film is preferable. This is because the Ni plating film is a metal film having excellent corrosion resistance, wear resistance, and chemical resistance, has good workability, and provides comparatively low treatment cost. The metal plating film 7a preferably has a thickness of 1 to 5 μm.

The CB 7b is a carbon material, which is chemically stable and has excellent electrical conductivity, slidability, and mechanical strength. Particulate CB can be used as the CB 7b. Particulate CB is preferably used, which has a particle diameter of several to 100 nm as measured by laser diffractometry or the like. The CB 7b is a product class having excellent electrical conductivity. The CB 7b has more excellent mass productivity than that of the CNT 4b, and can be comparatively inexpensively obtained. Thereby the CB 7b can reduce cost, which is preferable.

In the CB plating layer 7, the CBs 7b are preferably formed so as to be projected from the surface of the metal plating film 7a. That is, as shown in FIG. 10, some of the CBs 7b, or all of the CBs 7b contained in the metal plating film 7a are projected partly outside the surface of the metal plating film 7a. When a metal oxide film is formed on the surface of the metal plating film 7a, a part of the other CBs 7b are preferably in contact with an inoxidized portion located (deep part) inside a metal oxide film 7c formed on the surface of the metal plating film 7a. Thereby, the CBs 7b pass through the metal oxide film 7c formed on the surface of the metal plating film 7a in a solder reflow process or the like, and exist on the surface of the CB plating layer 7. Therefore, the other conductive member is directly electrically connected to a metal located inside (deep part) the metal plating film 7a through the CBs 7b having higher electric conductivity than that of the metal oxide film 7c having low electric conductivity. As a result, stably low contact resistance is obtained. It is considered that the adhesion and wear phenomena of the metal plating film 7a and the other metal conductive member are less likely to be generated by the CBs 7b existing on the surface of the CB plating layer 7, which can improve sticking resistance.

The CB plating layer 7 preferably includes the CBs 7b of 0.02 to 2.0% by mass based on the total amount thereof, and more preferably 0.02 to 1.0% by mass. When the content of the CBs 7b is within this range, an improvement in contact reliability of the CB plating layer 7 by the CBs 7b is sufficiently obtained. The dispersibility of the CBs 7b in the plating liquid and the adhesion of the CB plating layer 7 to the base material 3 can be sufficiently secured.

The solder joint plating layer 5 has higher solder wettability than that of the CB plating layer 7 as in the above-mentioned description. Since the CB itself has hydrophobicity and the CB plating layer 7 has large surface roughness, a solder is less likely to spread and to adhere tightly to the CB plating layer 7. Therefore, if the CB plating layer 7 is applied to the mounting part 2, there is a possibility that the joint strength of the electrical contact component A to the other conductive member is decreased, or much time and effort are taken to join the electrical contact component A, which deteriorates mountability. Accordingly, the solder joint plating layer 5 having more excellent solder wettability than that of the CB plating layer 7 is formed on the mounting part 2. The solder joint plating layer 5 can be directly formed on the surface of the base material 3 using a noble metal plating film having excellent electrical conductivity and made of Au or the like in the same manner as above. The same base plating layer 6 as the above may be interposed between the solder joint plating layer 5 and the surface of the base material 3.

The electrical contact component A using the CBs can be manufactured by selectively forming the CB plating layer 7 on a portion to be the contact point part 1, of the base material 3 formed in a desired shape and selectively forming the solder joint plating layer 5 on a portion to be the mounting part 2, of the above-mentioned base material 3.

When the CB plating layer 7 is selectively formed, the same various methods as the above can be employed. In this case, the CBs 7b may be incorporated in the plating liquid or the like in place of the CNTs 4b. The solder joint plating layer 5 and the base plating layer 6 can also be selectively formed by the same various methods as the above.

Contact reliability in a low contact pressure region can be secured even when the CBs 7b are used in the same manner as in the case where the CNTs 4b are used. Furthermore, a sticking phenomenon is less likely to occur, and an improvement in life of the electrical contact component can be easily achieved. The solder joint plating layer 5 having higher solder wettability than that of the CB plating layer 7 and made of Au or the like is formed on the mounting part 2, and thereby high mountability can be secured. Therefore, the above-mentioned electrical contact component A can achieve both the contact reliability and the mountability.

Hereinafter, the first embodiment of the present invention will be specifically described with reference to examples 1 to 3 and comparative examples 1 and 2.

### Example 1

A Cu alloy such as phosphor bronze or titanium copper was used as a material of a base material 3. The Cu alloy was molded into a shape applied to a copper plate or a contact point material of a switch.

A CNT plating layer 4 of a contact point part 1 was formed by an electrolysis plating method. In this case, a Ni plating liquid containing CNTs 4b was used. VGCF manufactured by Showa Denko K.K. was used as the CNT 4b. The CNTs 4b were used a mixture of single wall CNTs and multi wall CNTs. The Ni plating liquid contained the CNTs 4b, each of which has a diameter (outer diameter) of 100 to 200 nm and a length of 10 to 20 μm. The Ni plating liquid contained nickel sulfate (1 mol/dm³), nickel dichloride (0.2 mol/dm³), boron (0.5 mol/dm³), and a polycarboxylic acid (2×10⁻⁵ mol/dm³) having a molecular weight of 5000 as a dispersant. The mixed amount of the CNTs 4b was set to 2 g/dm³. The nickel plating liquid containing the CNTs 4b was used as a plating bath. Plating was carried out under plating conditions of a bath temperature of 25° C. and a current density of 1 to 5 A/dm². The CNT plating layer 4 was formed, which had a metal plating film 4a having a thickness of 5 μm and contained 0.02% by mass of the CNTs 4b.

A solder joint plating layer 5 of a mounting part 2 was laminated and formed on the surface of a base plating layer 6 formed on the surface of the base material 3. The base plating layer 6 was a Ni plating film having a thickness of 0.5 to 2 μm. Electrolytic plating was carried out for 1 minute under plating conditions of nickel sulfamate (450 g/l), nickel dichloride (3 g/l), boric acid (30 g/l), an additive (moderate amount), an antipit agent (moderate amount), pH=3.0 to 4.5, and a bath temperature of 40 to 50° C. The solder joint plating layer 5 was an Au plating film having a thickness of 0.2 μm. Electrolytic plating was carried out for 30 seconds under plating conditions of Au potassium cyanide (8 to 10 g/l), citric acid (60 to 90 g/l), cobalt (100 mg/l), a treatment temperature of 25 to 35° C., and a current density of 0.5 to 1.5 A/dm².

### Example 2

Example 2 was carried out in the same manner as in example 1 except that a CNT plating layer 4 was formed, which had a metal plating film 4a having a thickness of 20 μm.

### Example 3

Example 3 was carried out in the same manner as in example 1 except that CBs 7b were used in place of the CNTs 4b and the thickness of the metal plating film 4a was set to 2 μm, to form a CB plating layer 7. Vulcan XC-72 manufactured from Cabot Corporation was used as the CB 7b. The CB had a diameter (particle diameter) of 20 to 100 nm (or 20 to 40 nm).

### Comparative Example 1

Comparative example 1 was carried out in the same manner as in example 1 except that a nickel plating film containing no CNTs and having a thickness of 20 μm was formed on a contact point part 1 in place of the CNT plating layer 4.

### Comparative Example 2

Comparative example 2 was carried out in the same manner as in example 1 except that an Au—Co plating film containing no CNTs and having a thickness of 0.2 μm was formed on the contact point part 1 in place of the CNT plating layer 4.

(Observation of Surface Textures of CNT Plating Layer 4 and CB Plating Layer 7)

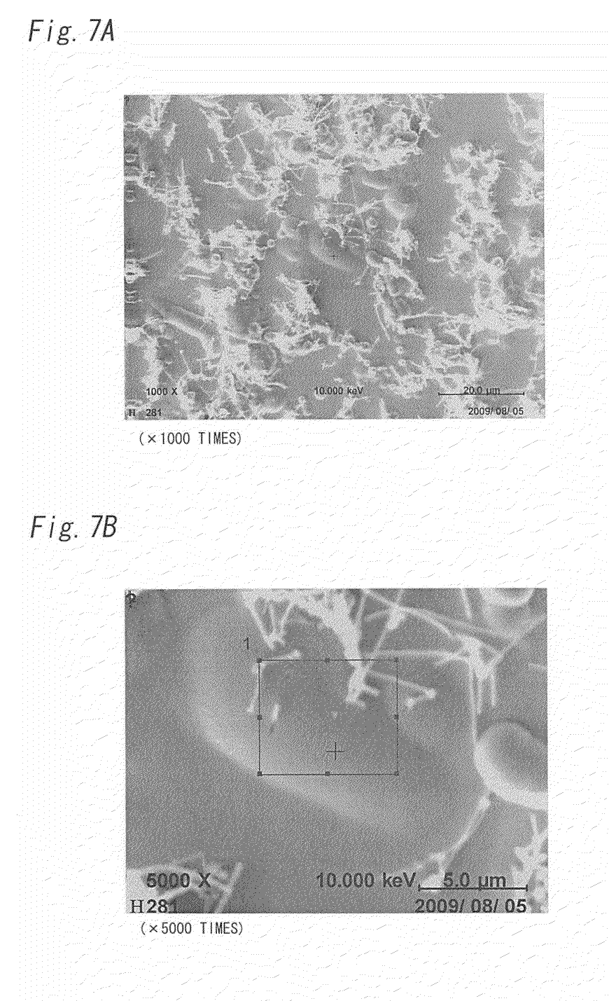

The surface texture of the CNT plating layer 4 formed in example 1 was observed in a scanning electron microscope (SEM) photograph (see FIGS. 7A and 7B). White linear or needle-shaped portions are the CNTs. The surface texture of the CB plating layer 7 formed in example 3 was observed in a scanning electron microscope (SEM) photograph (see FIG. 11).

(Evaluation of Contact Reliability)

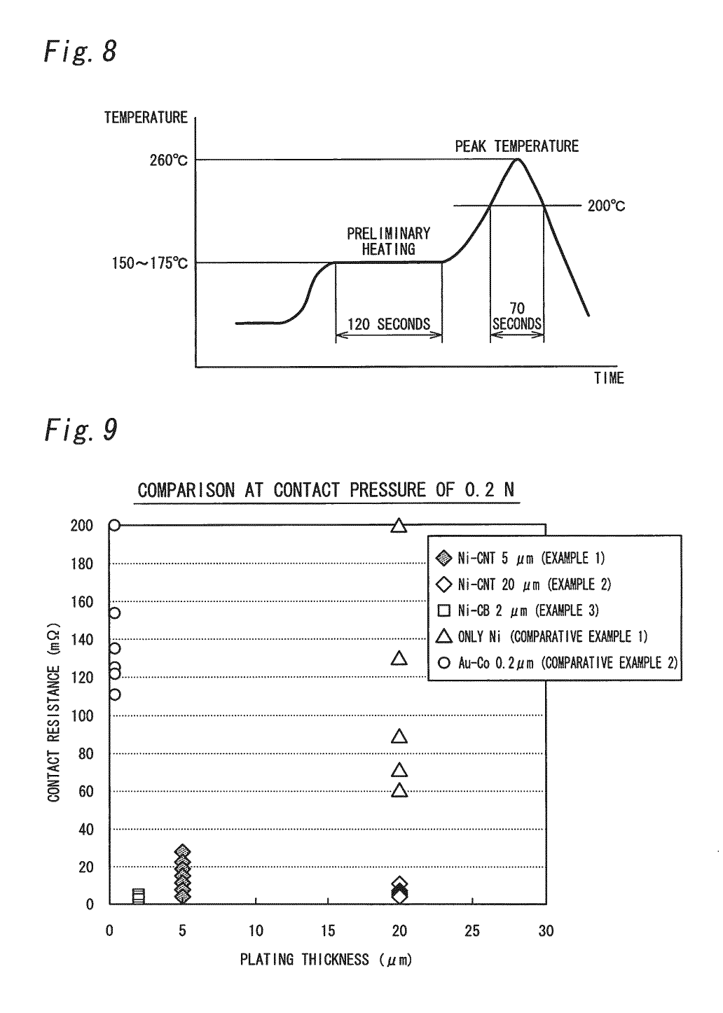

The contact resistance values of the contact point parts 1 after a heat treatment were measured for examples 1 to 3 and comparative examples 1 and 2. A temperature profile during the heat treatment is shown in FIG. 8. This assumed air reflow mounting using a lead-free solder. Three cycles of the heat treatment were carried out.

The contact resistance values were measured using an electric contact point simulator (model: CRS-113-AU type) manufactured by Yamazaki-Seiki Co., Ltd. In measurement using an alternate current four terminal method, the measured values include no specific resistance such as a lead wire or a connector part. The contact resistance values when a contact load is changed can be measured. A contact position can be scanned in a fixed load by an electrical stage, and measurement assuming wiping in a switch or a relay contact point can also be carried out. The contact resistance values were measured in a contact force of 0.2 N. The results are shown in FIG. 9.

As is obvious from the results, it can be said that examples 1 to 3 have a smaller contact resistance value than those of comparative examples 1 and 2 and higher contact reliability in a low contact pressure region.

### (Evaluation of Mountability)

The solder wettabilities of lead-free solder pastes were evaluated for examples 2 and 3 and comparative example 2.

The lead-free solder paste was applied onto the surface of the CNT plating layer or CB plating layer such that the lead-free solder paste had a shape of a circle having a diameter of 4.5 mm using a mask screen having a thickness of 0.12 mm. M705-221BM5-32-11.2K manufactured by Senju Metal Industry Co., Ltd. was used as the solder paste. Reflow using the temperature profile of FIG. 8 under the atmosphere was used as a mounting condition. A solder ball diameter after reflow was measured, and the ratio of the solder ball diameter after reflow to that before reflow was calculated to estimate the solder wettabilities. The evaluation results are shown in Table 1.

TABLE 1

| | Solder diameter, | | |
|---|---|---|---|
| | actual measured value | | Ratio % |
| | Before | After | (After reflow/before |
| Samples | reflow | reflow | reflow) ×100 |
| Solder joint plating layer | 4.48 mm | 5.59 mm | 125% |
| (Au—Co plating): use | | | |
| of comparative example 2 | | | |
| CNT plating layer (CNT | 4.47 mm | 1.87 mm | 42% |
| composite Ni plating): use | | | |
| of example 2 | | | |
| CB plating layer (CB | 4.48 mm | 1.39 mm | 31% |
| composite Ni plating): use | | | |
| of example 3 | | | |

It was found that the ratio (after reflow/before reflow) is 125% in comparative example 2 (Au plating article), and the solder is likely to wet and spread to obtain a good mounting result. In contrast, it was found that the ratio is 42% in example 2 (CNT plating layer), and the solder is repelled. It is considered that this results from the fact that both the nickel oxide layer and the CNTs contained in the surface of the CNT plating layer have a hydrophobic action. Therefore, it can be said that the CNT plating layer is selectively formed on the contact point part, and the Au plating film is provided on the solder mounting part, thereby providing the practical best constitution. It can be said that example 3 using the CBs is also the same.

### Second Embodiment

Hereinafter, a second embodiment of the present invention will be described. The same members as those in the first embodiment are represented by the same reference numbers, and the repeated descriptions thereof will be omitted.

In the above-mentioned first embodiment, the CNT plating layer 4 containing the CNTs 4b and the CB plating layer 7 containing the CBs 7b was formed of the metal plating films 4a and 7a formed of the material such as Cu and Ni. Meanwhile, a plating layer containing a nanocarbon material 8 (for example, CNTs or CBs) of the present embodiment is characterized in that the plating layer is an amorphous plating layer 9.

A contact point part 1 is formed by providing the amorphous plating layer 9 containing the nanocarbon material 8 on a surface of a base material 3 of an electrical contact component A. A mounting part 2 is formed by providing, on the surface of the base material 3, a plating layer (hereinafter, referred to as a “solder joint plating layer”) 15 having higher solder wettability than that of the amorphous plating layer 9 containing the nanocarbon material 8.

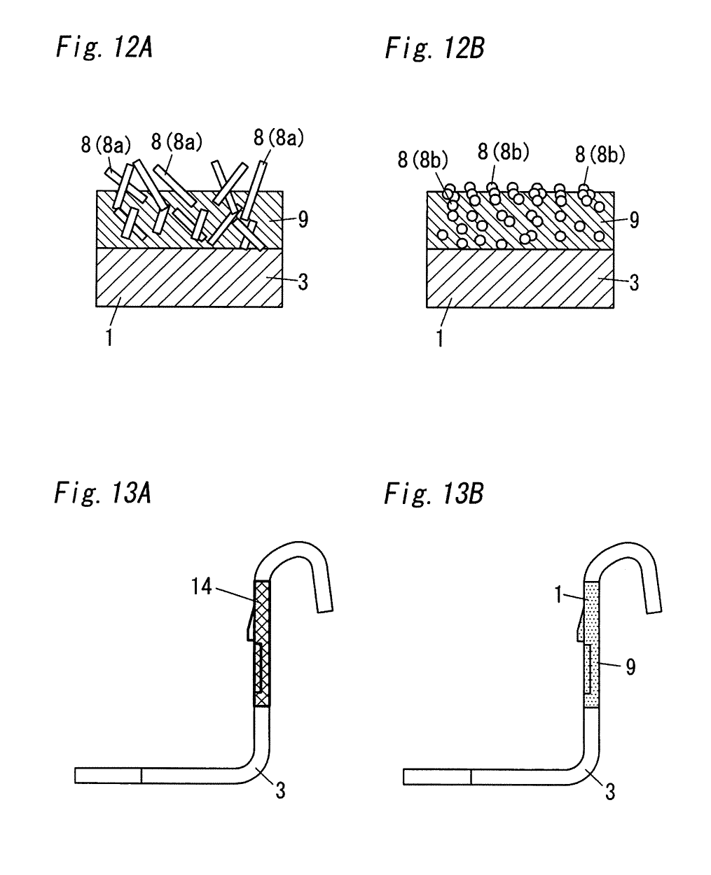

The amorphous plating layer 9 is formed of an amorphous metal plating film adhering to the surface of the base material 3, as shown in FIGS. 12A and 12B. The nanocarbon materials 8 are incorporated in a dispersed state in the amorphous plating layer 9. The amorphous plating layer 9 is formed as composite plating.

The material and thickness or the like of the amorphous plating layer 9 may be determined in consideration of adherability of the amorphous plating layer 9 to the base material 3, performance of holding the nanocarbon material 8, and hardness and corrosion resistance of the amorphous plating layer 9, or the like. For example, the amorphous plating layer 4 can be formed of a material such as a Ni alloy. Specific examples thereof include a Ni—P alloy plating film, a Ni—Sn alloy plating film, a Ni—W alloy plating film, a Ni—Mo alloy plating film, and a Ni—B alloy plating film. Among them, the Ni—P alloy plating film is preferable, which has excellent corrosion resistance, wear resistance, and chemical resistance, has good workability, and provides comparatively low treatment cost. The concentrations of components (phosphorus (P), tin (Sn), tungsten, molybdenum (Mo), and boron (B) or the like) other than nickel (Ni) in the amorphous plating layer 4 are preferably 6 to 12%. When the concentrations are in this range, the metal plating film of the amorphous plating layer 9 is not too hard, which is less likely to cause the generation of a crack or the like, and can secure corrosion resistance. The amorphous plating layer 9 preferably has a thickness of 5 μm or less. When the thickness is thicker than 5 μm, the spring property of the contact point part 1 is apt to be lost, and a crack caused by a stress is apt to be generated. Thereby, the thickness of the amorphous plating layer 9 is preferably set as described above so that no problem on quality occurs. The lower limit of the thickness of the amorphous plating layer 9 is preferably 1 μm in order to obtain the effect of the present invention, but is not limited thereto.

It is preferable that the nanocarbon material 8 is a nano-order carbon material such as a CNT 8a or CB 8b, is chemically stable, and has excellent electrical conductivity, slidability, and mechanical strength. A CNT having a diameter of 100 to 200 nm and a length of 10 to 20 μm is used as the CNT 8a. Examples of the CNT 8a includes a single wall CNT (single wall carbon nanotube) and a multi wall CNT (multi wall carbon nanotube: hereinafter, MWCNT). The single wall CNT is obtained by cylindrically rolling a graphite sheet as one layer. The MWCNT is obtained by rolling two or more graphite sheets as a multi-layer. The MWCNT has more excellent mass productivity than that of the single wall CNT, and can be comparatively inexpensively obtained. Thereby the MWCNT can reduce cost, which is preferable. Particulate CB can be used as the CB 8b. Particulate CB is preferably used, which has a particle diameter of several to 100 nm as measured by laser diffractometry or the like. The CB 8b is a product class having excellent electrical conductivity. The CBs 8b preferably exist in a state of a cluster-like aggregate having a micron-order size or less. The CB 8b has more excellent mass productivity than that of the CNT 8a, and can be comparatively inexpensively obtained. Thereby the CB 8b can reduce cost, which is preferable.

The nanocarbon material 8 is projected from the surface of the amorphous plating layer 9. That is, as shown in FIGS. 12A and 12B, some of the nanocarbon materials 8 contained in the amorphous plating layer 9, or all of the nanocarbon materials 8 contained in the amorphous plating layer 9 are projected partly and exposed outside the surface of the amorphous plating layer 9, or are exposed from the surface by sliding and opening/closing or the like of the contact point part. When a metal oxide film is formed on the surface of the amorphous plating layer 9, the nanocarbon material 8 is preferably in contact with an inoxidized portion located inside (deep part) the metal oxide film formed on the amorphous plating layer 9. Thereby, the nanocarbon material 8 passes through the metal oxide film in a solder reflow process or the like, and exists on the surface of the amorphous plating layer 9. Therefore, the other conductive member is directly electrically connected to a metal located inside (deep part) the amorphous plating layer 9 through the nanocarbon material 8 having higher electric conductivity than that of the metal oxide film having low electric conductivity. As a result, stably low contact resistance is obtained. It is considered that the adhesion and wear phenomena of the amorphous plating layer 9 and the other metal conductive member are less likely to be generated by the nanocarbon material 8 existing on the surface of the amorphous plating layer 9, which can improve sticking resistance.

The amorphous plating layer 9 containing the nanocarbon material 8 preferably contains the nanocarbon material 8 of 0.02 to 2.0% by mass based on the total amount (the sum total of the amorphous plating layer 9 and the nanocarbon material 8) thereof. When the content of the nanocarbon material 8 is within the above-mentioned range, an improvement in contact reliability of the contact point part 1 by the nanocarbon material 8 is sufficiently obtained. The dispersibility of the nanocarbon material 8 in a plating liquid and the adhesion of the amorphous plating layer 9 to the base material 3 can be sufficiently secured.

The solder joint plating layer 15 has higher solder wettability than that of the amorphous plating layer 9 containing the nanocarbon material 8. Since the nanocarbon material 8 itself has hydrophobicity and the amorphous plating layer 9 containing the nanocarbon material 8 has large surface roughness, a solder is less likely to spread and to adhere tightly to the amorphous plating layer 9. Therefore, if the amorphous plating layer 9 containing the nanocarbon material 8 is applied to the mounting part 2, there is a possibility that the joint strength of the electrical contact component A to the other conductive member is decreased, or much time and effort are taken to join the electrical contact component A, which deteriorates mountability. Accordingly, the solder joint plating layer 15 having more excellent solder wettability than that of the amorphous plating layer 9 containing the nanocarbon material 8 is formed on the mounting part 2. The solder joint plating layer 15 can be directly formed on the surface of the base material 3 using a noble metal plating film made of Au, Ag, Pt, Rh, Ru, Ir, Pd, or an alloy thereof or the like having excellent electrical conductivity, for example. As shown in FIG. 18, a base plating layer 16 may be interposed between the solder joint plating layer 15 and the surface of the base material 3. In this case, a Ni plating film having excellent adhesion with the base material 3 can be used as the base plating layer 16. An Au plating film and an Au—Pd alloy plating film or the like which have excellent electrical conductivity can be used as the solder joint plating layer 15 laminated on the surface of the base plating layer 16. The thickness of the base plating layer 16 is preferably 0.5 to 2 μm. The thickness of the solder joint plating layer 15 is preferably 0.01 to 5 μm, and more preferably 0.1 to 0.5 μm.

The above-mentioned electrical contact component A can be manufactured by selectively forming the amorphous plating layer 9 containing the nanocarbon material 8 on a portion to be the contact point part 1, of the base material 3 formed in a desired shape and selectively forming the solder joint plating layer 15 on a portion to be the mounting part 2, of the above-mentioned base material 3.

When the amorphous plating layer 9 containing the nanocarbon material 8 is selectively formed, various methods can be employed. For example, when a spot plating method is employed, in the same manner as in FIG. 3 described in the first embodiment, the amorphous plating layer 9 containing the nanocarbon material 8 can be formed by partially spraying a plating liquid 11 onto a place on which the amorphous plating layer 9 containing the nanocarbon material 8 is formed, on the surface of the base material 3 from a nozzle 10. The plating liquid 11 contains a metal component for forming the amorphous plating layer 9, and the nanocarbon material 8. Alternatively, the surface of the base material 3 can also be partially plated using a sparger.

The amorphous plating layer 9 containing the nanocarbon material 8 can also be selectively formed by a mask plating method. In this case, in the same manner as in FIG. 4 in described in the first embodiment, a portion (for example, a place to be the mounting part 2) other than a place on which the amorphous plating layer 9 containing the nanocarbon material 8 is formed, on the surface of the base material 3 is covered with a mask 12. The base material 3 on which the mask 12 is provided is then immersed in the plating liquid. Then, the amorphous plating layer 9 containing the nanocarbon material 8 can be formed on a place which is not covered with the mask 12, of the base material 3 by electrolytic plating or non-electrolytic plating.

The amorphous plating layer 9 containing the nanocarbon material 8 can also be selectively formed by a resist plating method. In this case, in the same manner as in FIG. 5 described in the first embodiment, a portion (for example, a place to be the mounting part 2) other than a place on which the amorphous plating layer 9 containing the nanocarbon material 8 is formed, on the surface of the base material 3 is covered with a resist film 13 (represented by hatching in FIG. 5). The base material 3 on which the resist film 13 is provided is then immersed in the plating liquid. Then, the amorphous plating layer 9 containing the nanocarbon material 8 can be formed on a place which is not covered with the resist film 13, of the base material 3 by electrolytic plating or non-electrolytic plating.

The amorphous plating layer 9 containing the nanocarbon material 8 can also be selectively formed by a catalyst plating method. In this case, as shown in FIG. 13A, a plating catalyst (a hatching part of FIG. 13A) 14 adheres to a place on which the amorphous plating layer 9 containing the nanocarbon material 8 is formed, of the surface of the base material 3. Then, the base material 3 on which the plating catalyst 14 is provided is immersed in the plating liquid. Then, the amorphous plating layer (a dotted pattern portion of FIG. 13B) 9 containing the nanocarbon material 8 can be formed on the place to which the plating catalyst 14 adheres, of the base material 3 by non-electrolytic plating, as shown in FIG. 13B.

The solder joint plating layer 15 and the base plating layer 16 can also be selectively formed by a known plating method such as sparger plating, partial immersion, felt plating, or spot plating, or the same plating method as that in the case of the amorphous plating layer 9 containing the nanocarbon material 8.

The amorphous plating layer 9 containing the nanocarbon material 8 is formed on the contact point part 1 in the above-mentioned electrical contact component A. Therefore, the contact point part 1 can provide an electrical connection in a state where the contact of the contact point part 1 with the other conductive member is secured by the nanocarbon material 8 even at a low contact pressure. The contact point part 1 can secure the contact reliability in the low contact pressure region even after solder reflow. The nanocarbon material 8 is interposed between the amorphous plating layer 9 and the other conductive member. Therefore, the adhesion and wear between the amorphous plating layer 9 and the other conductive member can be reduced, and the sticking resistance can be improved. Furthermore, the amorphous plating layer 9 containing the nanocarbon material 8 can have less sliding wear and higher hardness than those of a plating layer made of only a metal, and thereby an improvement in life of the electrical contact component A can be achieved. Furthermore, it is not necessary to finely manage an eutectoid amount in order to improve the contact reliability. It is not necessary to perform a sealing treatment in order to improve the corrosion resistance. Therefore, process management is not complicated and the contact reliability is not deteriorated, which enables inexpensive manufacture.

Therefore, when the above-mentioned electrical contact component A is used as a contact point component (contact point material) such as a switch or a relay having a high opening and closing frequency, a sticking phenomenon is less likely to occur, and the improvement in life of the contact point component can be easily achieved, which is preferable. Noble metal plating such as Au plating may not be used for the contact point part 1, and thereby the electrical contact component A having high reliability can be provided at low cost. Meanwhile, the solder joint plating layer 15 having higher solder wettability than that of the amorphous plating layer 9 and made of Au or the like is formed on the mounting part 2, and thereby high mountability can be secured. Therefore, the above-mentioned electrical contact component A can achieve both the contact reliability and the mountability. Furthermore, the electrical contact component A has high corrosion resistance and can be inexpensively manufactured.

Hereinafter, the second embodiment of the present invention will be specifically described with reference to examples 4 to 6 and comparative examples 3 to 5.

### Example 4

A Cu alloy such as phosphor bronze or titanium copper was used as a material of a base material. The Cu alloy was molded into a shape applied to a copper plate or a contact point material of a switch.

An amorphous plating layer containing a nanocarbon material of a contact point part 1 was formed by an electrolysis plating method. In this case, a Ni—P plating liquid containing CNTs was used as the nanocarbon material. VGCF manufactured by Showa Denko K.K. was used as the CNT. The CNTs were used as a mixture of single wall CNTs and multi wall CNTs. The Ni—P plating liquid contains the CNTs, each of which has a diameter (outer diameter) of 100 to 200 nm and a length of 10 to 20 μm. The Ni—P plating liquid was used, which contained nickel sulfate (1 mol/dm³), nickel dichloride (0.2 mol/dm³), and boron (0.5 mol/dm³). In the Ni—P plating liquid containing the CNTs, the mixed amount of the CNTs was set to 2 g/dm³. The Ni—P plating liquid containing the CNTs was used as a plating bath. Plating was carried out under plating conditions of a bath temperature of 25° C. and a current density of 1 to 5 A/dm². A Ni—P alloy plating layer containing the CNTs was formed. The Ni—P alloy plating layer had an amorphous plating layer having a thickness of 5 μm and contained 0.02% by mass of the CNTs.

A solder joint plating layer 15 of the mounting part 2 was laminated and formed on the surface of a base plating layer 16 formed on the surface of the base material 3. The base plating layer 16 was a Ni plating film having a thickness of 0.5 to 2 μm. Electrolytic plating was carried out for 1 minute under plating conditions of nickel sulfamate (450 g/l), nickel dichloride (3 g/l), boric acid (30 g/l), an additive (moderate amount), an antipit agent (moderate amount), pH=3.0 to 4.5, and a bath temperature of 40 to 50° C. The solder joint plating layer 15 was an Au-plating film having a thickness of 0.2 μm. Electrolytic plating was carried out for 30 seconds under plating conditions of Au potassium cyanide (8 to 10 g/l), citric acid (60 to 90 g/l), cobalt (100 mg/l), a treatment temperature of 25 to 35° C., and a current density 0.5 to 1.5 A/dm².

### Example 5

Example 5 was carried out in the same manner as in example 4 except that CBs were used as the nanocarbon material in place of the CNTs, to form a Ni—P alloy plating layer containing the CBs. Vulcan XC-72 manufactured from Cabot Corporation was used as the CB. The CB has a diameter (particle diameter) of 20 to 100 nm (or 20 to 40 nm).

### Example 6

Example 6 was carried out in the same manner as in example 5 except that a Ni—P alloy plating layer containing CBs was formed, which had an amorphous plating layer having a thickness of 2 μm.

### Comparative Example 3

Comparative example 3 was carried out in the same manner as in example 4 except that a Ni—P alloy plating layer containing no CNTs was formed on a contact point part 1 in place of the Ni—P alloy plating layer containing the CNTs.

### Comparative Example 4

Comparative example 4 was carried out in the same manner as in example 4 except that an Au—Co alloy plating layer containing no CNTs was formed on a contact point part 1 in place of the Ni—P alloy plating layer containing the CNTs.

### Comparative Example 5

Comparative example 5 was carried out in the same manner as in comparative example 3 except that a Ni—P alloy plating layer containing no CNTs was formed using a Ni—P alloy-plating liquid containing a polycarboxylic acid (2×10⁻⁵ mol/dm³) having a molecular weight of 5000 as a dispersant.

(Observation of Surface Textures of Ni—P Alloy Plating Layer Containing CNTs and Ni—P Alloy Plating Layer Containing CBs)

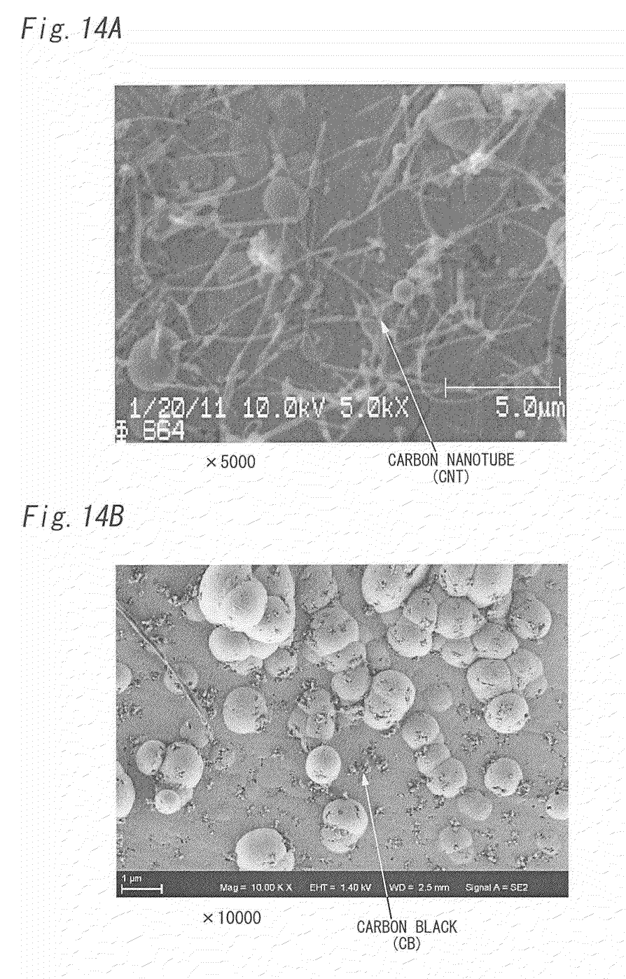

The surface texture of the Ni—P alloy plating layer containing the CNTs, formed in example 4 was observed in a scanning electron microscope (SEM) photograph (see FIG. 14A). White linear or needle-shaped portions are the CNTs. The surface texture of the Ni—P alloy plating layer containing the CBs, formed in example 5 was observed in a scanning electron microscope (SEM) photograph (see FIG. 14B).

(Evaluation of Contact Reliability)

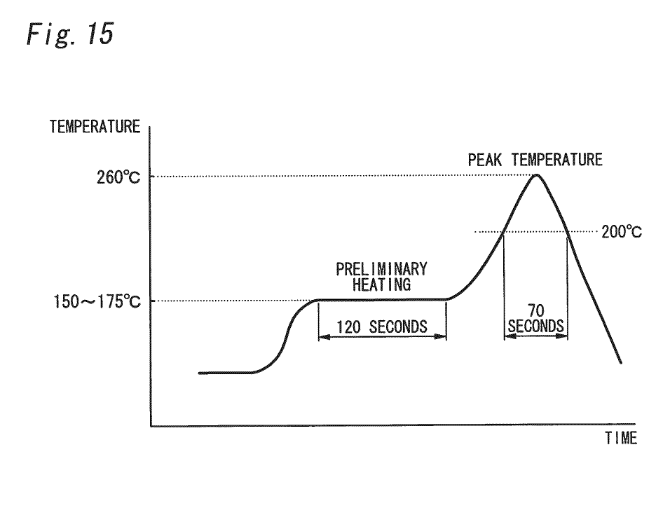

The contact resistance values of the contact point parts 1 after a heat treatment were measured for examples 4 to 6 and comparative examples 3 to 5. A temperature profile during the heat treatment is shown in FIG. 15. This assumed air reflow mounting using a lead-free solder. Three cycles of the heat treatment were carried out at a peak temperature of 260° C.

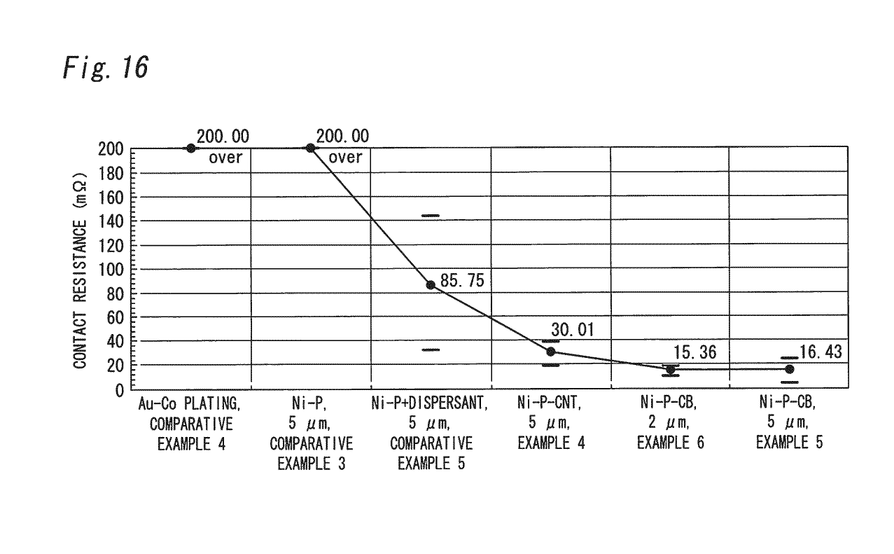

The contact resistance values were measured using an electric contact point simulator (model: CRS-113-AU type) manufactured by Yamazaki-Seiki Co., Ltd. In measurement by an alternate current four terminal method, the measured values include no specific resistance such as a lead wire or a connector part. The contact resistance values when a contact load is changed can be measured. A contact position can be scanned in a fixed load by an electrical stage, and measurement assuming wiping in a switch or a relay contact point can also be carried out. The contact resistance values were measured in a contact force of 0.1 N. Ten samples were prepared and measured from each of examples 4 to 6 and comparative examples 3 to 5. The results are shown in FIG. 16.

As is obvious from the results, it can be said that examples 4 to 6 have a smaller contact resistance value and higher contact reliability in a low contact pressure region than those of comparative examples 3 to 5.

(Evaluation of Corrosion Resistance)

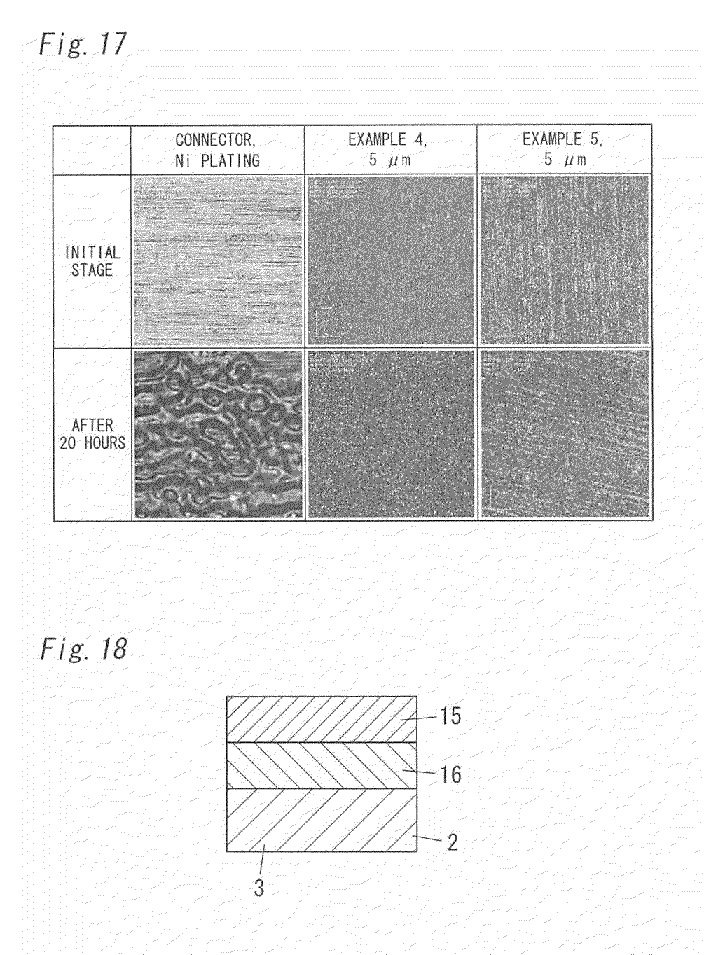

Corrosion resistance was evaluated according to a sulfite resistance test for examples 4 and 5, and a connector with Ni plating. That is, examples 4 and 5, and the connector with Ni plating were left for 20 hours under conditions of a temperature of 60° C., a humidity of 95%, and a sulfite gas concentration of 10 ppm, and degrees of corrosion were observed. Photographs of examples 4 and 5, and the connector with Ni plating before or after the test are shown in FIG. 17. In the normal connector with Ni plating, the corrosion proceeds into the plating film, and the elevation of a sulfide film is produced on the surface. In the Ni—P alloy plating layer containing the CNTs of example 4 and the Ni—P alloy plating layer containing the CBs of example 5, an extremely small surface layer portion is sulfurated. However, the corrosion toward the inside of the plating film is suppressed, and thereby a large external appearance difference before and after the test cannot be seen.

While the present invention has been described with reference to some preferred embodiments, various changes and modifications can be made by one skilled in the art without departing from the original spirit and scope thereof, that is, Claims.

1. An electrical contact component comprising:
a contact point part configured to provide an electrical connection by contact, the contact point part having a surface having a plating layer selectively formed thereon, the plating layer comprising carbon nanotubes or carbon blacks; and
a mounting part configured to provide an external electrical connection by solder joining, the mounting part having a plating layer formed thereon, the plating layer having higher solder wettability than that of the plating layer comprising the carbon nanotubes or carbon blacks.

2. The electrical contact component according to claim 1, wherein the carbon nanotubes or carbon blacks are projected from a surface of the plating layer comprising the carbon nanotubes or carbon blacks.

3. The electrical contact component according to claim 1, wherein the plating layer comprising the carbon nanotubes or carbon blacks is formed by electrolytic plating or non-electrolytic plating.

4. The electrical contact component according to claim 1, wherein the carbon nanotubes comprise multi wall carbon nanotubes.

5. The electrical contact component according to claim 1, wherein the plating layer comprising the carbon nanotubes comprises the carbon nanotubes of 0.02 to 2.0% by mass based on the total amount thereof.

6. The electrical contact component according to claim 1, wherein the plating layer comprising the carbon blacks comprises the carbon blacks of 0.02 to 2.0% by mass based on the total amount thereof.

7. The electrical contact component according to claim 1, wherein the plating layer comprising the carbon nanotubes or carbon blacks is an amorphous plating layer, and the carbon nanotubes or carbon blacks are exposed from a surface of the amorphous plating layer.

8. The electrical contact component according to claim 7, wherein the amorphous plating layer is a Ni—P alloy plating film.

9. An electrical contact component having a surface with an amorphous plating layer formed thereon,
wherein the amorphous plating layer comprises a nanocarbon material exposed from a surface of the amorphous plating layer.

10. The electrical contact component according to claim 9, wherein the electrical contact component comprises a contact point part configured to provide an electrical connection by contact, and a mounting part configured to provide an electrical connection by solder joining;
the contact point part has the surface having the amorphous plating layer formed thereon; and
the mounting part has a plating layer formed thereon, the plating layer having higher solder wettability than that of the amorphous plating layer.

11. The electrical contact component according to claim 9, wherein the nanocarbon material includes multi wall carbon nanotubes.

12. The electrical contact component according to claim 9, wherein the nanocarbon material includes carbon blacks.

13. The electrical contact component according to claim 9, wherein the amorphous plating layer comprises the nanocarbon material of 0.02 to 2.0% by mass based on the total amount thereof.

14. The electrical contact component according to claim 9, wherein the amorphous plating layer is formed by electrolytic plating or non-electrolytic plating.

15. The electrical contact component according to claim 9, wherein the amorphous plating layer is a Ni—P alloy plating film.

16. The electrical contact component according to claim 2, wherein the plating layer comprising the carbon nanotubes or carbon blacks is formed by electrolytic plating or non-electrolytic plating.

17. The electrical contact component according to claim 10, wherein the nanocarbon material includes multi wall carbon nanotubes.

18. The electrical contact component according to claim 10, wherein the nanocarbon material includes carbon blacks.
